(19) United States
(12) Patent Application Publication
(10) Pub. No.: US 2014/0379608 A1
(43) Pub. Date: Dec. 25, 2014

(54) CARTON INVENTORY OPTIMIZATION

(71) Applicant: United Parcel Service of America, Inc., Atlanta, GA (US)

(72) Inventor: Thomas J. Buettner, Centuria, WI (US)

(21) Appl. No.: 13/921,406

(22) Filed: Jun. 19, 2013

(51) Int. Cl. G06Q 10/08

(52) U.S. Cl. CPC G06Q 10/0838
USPC 705/341

(57) ABSTRACT

Computer program products, methods, systems, apparatus, and computing entities for carton inventory optimization are provided. An example method comprises: (a) receiving historical shipping data corresponding to a time period, the historical shipping data comprising items that were shipped during the time period and their respective dimensions; (b) associating a rank to each of a plurality of carton sizes for each item; (c) associating a highest ranked carton size for each item at least in part on step (b); and (d) determining whether a desired level of optimization has been reached. Another example method may further comprise: (e) after determining that the desired level of optimization has not been reached, identifying at least one carton size; and (f) re-associating items that were associated with the at least one identified carton size to the next highest ranked carton size for each item.

### BACKGROUND

In some instances, cost of shipping an item may depend on the dimensions of the shipping carton. Additionally, if there is empty space in the shipping carton, the empty space often must be filled with packing peanuts, bubble wrap, or other packing material. Thus, when a shipper would like to ship a product, the shipper would like to use a shipping carton that includes minimal empty or waste space within the carton, therefore optimizing shipping efficiency and maintaining environmentally friendly practices. For frequent shippers, the carton used to ship the product is often selected from a supply of shipping cartons kept in stock in, for example, a shipper's warehouse or storeroom. Thus, there is a need in the art for methods, systems, apparatus, and computer program products for determining which cartons a consigner should keep in stock in order to minimize the waste space in the shipping cartons of shipped products.

### BRIEF SUMMARY

In general, embodiments of the present invention provide methods, apparatus, systems, computing devices, computing entities, and/or the like for determining the optimal selection of cartons a consigner should keep in stock.

In accordance with one aspect, a method for determining the optimal cartons for a consigner to keep in stock is provided. In one embodiment, the method comprises the steps of: (a) receiving historical shipping data corresponding to a time period, the historical shipping data comprising items that have been shipped during the time period and their respective dimensions; (b) associating a rank to each of a plurality of carton sizes for each item; (c) associating a highest ranked carton size for each item based at least in part on step (b); and (d) determining whether a desired level of optimization has been reached. In another embodiment, the method further comprises the steps of: (e) after determining that the desired level of optimization has not been reached, identifying at least one carton size; and (f) re-associating items that were associated with the at least one identified carton size to the next highest ranked carton size for each item.

In accordance with another aspect, a computer program product for carton inventory optimization is provided. The computer program product may comprise at least one computer-readable storage medium having computer-readable program code portions stored therein, the computer-readable program code portions comprising executable portions configured to (a) receive historical shipping data corresponding to a time period, the historical shipping data comprising items that have been shipped during the time period and their respective dimensions; (b) associate a rank to each of a plurality of carton sizes for each item; (c) associate a highest ranked carton size for each item based at least in part on (b); and (d) determine whether a desired level of optimization has been reached. In another embodiment the computer program product may comprise computer-readable program code portions further comprising executable portions configured to (e) after it is determined that the desired level of optimization has not been reached, identify at least one carton size; and (f) an executable portion configured to re-associate items that were associated with the at least one identified carton size to the next highest ranked carton size for each item.

In accordance with yet another aspect, an apparatus comprising at least one processor and at least one memory including computer program code is provided. In one embodiment, the at least one memory and the computer program code may be configured to, with the processor, cause the apparatus to (a) receive historical shipping data corresponding to a time period, the historical shipping data comprising items that have been shipped during the time period and their respective dimensions; (b) associate a rank to each of a plurality of carton sizes for each item; (c) associate a highest ranked carton size for each item based at least in part on (b); and (d) determine whether a desired level of optimization has been reached. In another embodiment, the at least one memory and the computer program code may be further configured to, with the processor cause the apparatus to (e) after it is determined that the desired level of optimization has not been reached, identify at least one carton size; and (f) re-associate items that were associated with the at least one identified carton size to the next highest ranked carton size for each item.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a carton optimization system according to various embodiment of the present invention.

FIG. 3 is a flowchart illustrating operations and processes that can be used in accordance with various embodiments of the present invention.

FIG. 4 is a flowchart illustrating various processes that may be completed by the historical shipping module according to various embodiments of the present invention.

FIG. 5 is a flowchart illustrating various processes that may be completed by the carton optimization module according to various embodiments of the present invention.

FIG. 6 is a chart illustrating a portion of a carton database according to various embodiments of the present invention.

FIG. 7 is an example of a screen that may be displayed to a user of the present invention according to various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

For the purposes of this Application, the following terms have the following definitions:

“End User” or “User” may refer to a computer, entity, or human user utilizing a system operating the present invention.

“Carton” may refer to any shipping container, bag, sleeve, covering, package, box, carton, envelope and/or the like that can be used for shipping an item.

“Recipient” or “Consignee” may refer to an individual, company, entity, party, or location intended to receive a package.

“Sender” or “Consignor” may refer to an individual, company, entity, party, or location sending a package containing an item for a recipient.

“Shipping carrier” or “carrier” may refer to any shipping company, shipping facility, individual shipper, or entity involved with shipping a package from a sender to a recipient. An example of a shipping carrier may include UPS.

### I. Computer Program Products, Methods, and Computing Entities

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory, multimedia memory cards (MMC), secure digital (SD) memory cards, Memory Sticks, and/or the like. Further, a non-volatile computer-readable storage medium may also include conductive-bridging random access memory (CBRAM), phase-change random access memory (PRAM), ferroelectric random-access memory (FeRAM), resistive random-access memory (RRAM), Silicon-Oxide-Nitride-Oxide-Silicon memory (SONOS), racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Rambus in-line memory module (RIMM), dual in-line memory module (DIMM), single in-line memory module (SIMM), video random access memory VRAM, cache memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing devices, computing entities, and/or the like carrying out instructions on a computer-readable storage medium for execution. Such embodiments can produce specifically-configured machines performing the steps or operations specified in the block diagrams and flowchart illustrations. Accordingly, the block diagrams and flowchart illustrations support various combinations of embodiments for performing the specified steps or operations.

### II. Exemplary System Architecture

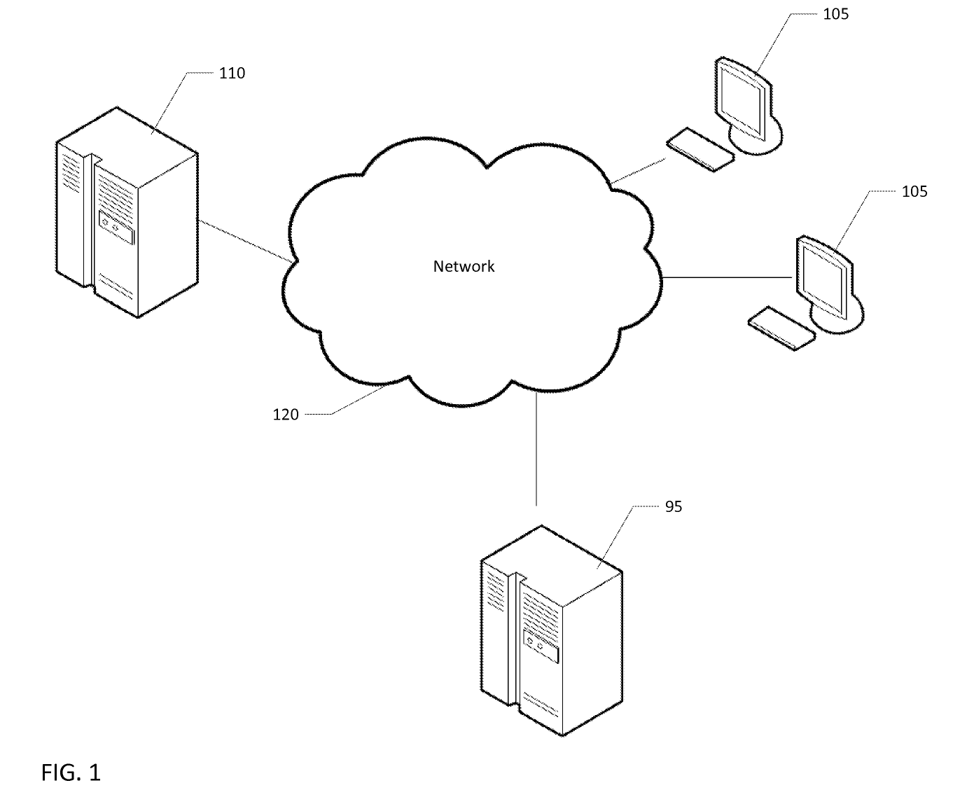

FIG. 1 provides an illustration of an exemplary embodiment of the present invention. As shown in FIG. 1, this particular embodiment may include one or more carton optimization systems 95, one or more consignor computing entities 105, one or more carrier systems 110, and one or more networks 120. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Carton Optimization System

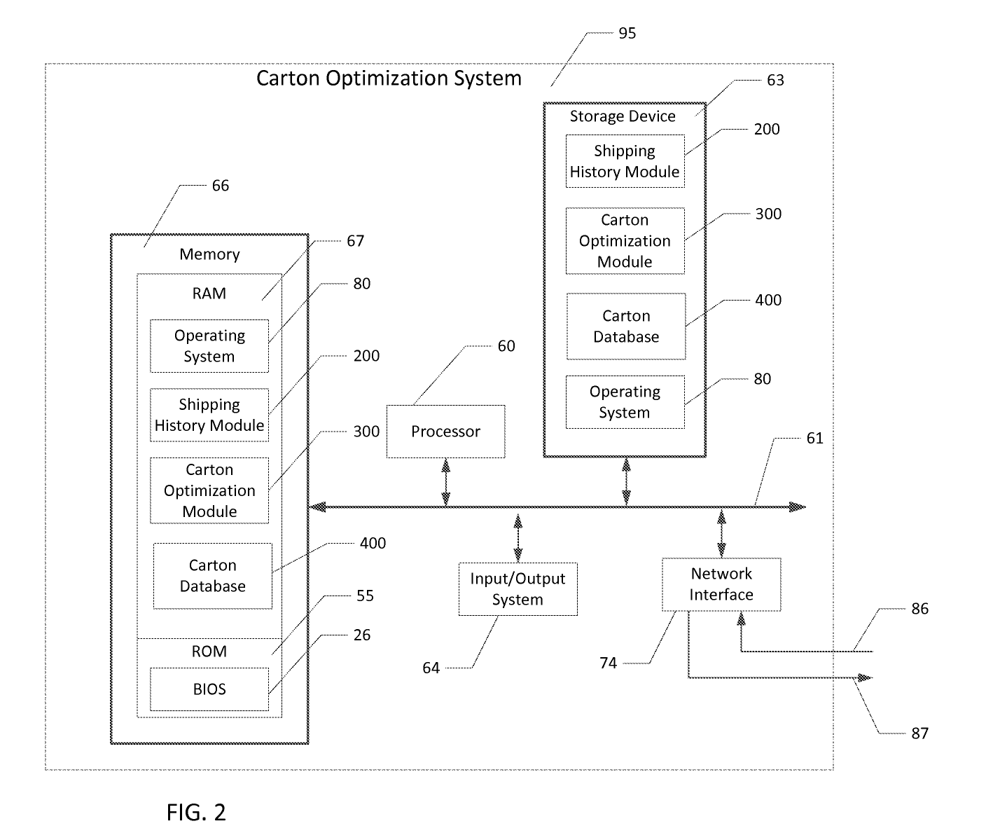

FIG. 2 provides a schematic of a carton optimization system 95 according to at least one embodiment of the present invention. In general, the terms computing entity, entity, device, system, and/or similar words used herein interchangeably may refer to, for example, one or more computers, computing entities, computing devices, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

The carton optimization system 95 comprises a processor 60, such as one or more processing elements, which may include complex programmable logic devices (CPLDs), microprocessors, multi-core processors, coproces sing entities, application-specific instruction-set processors (ASIPs), and/or controllers or other processing devices or circuitry. The term circuitry may refer to an entirely hardware embodiment or a combination of hardware and computer program products. Thus, the processor 60 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processor 60 may be configured for a particular use or configured to execute instructions stored in volatile or non-volatile media or otherwise accessible to the processor 60. As such, whether configured by hardware or computer program products, or by a combination thereof, the processor 60 may be capable of performing steps or operations according to embodiments of the present invention when configured accordingly. The processor 60 is used to execute software instructions for carrying out the defined steps of the method of the various embodiments of the present invention. The processor 60 communicates using a data bus 61 that is used to convey data and program instructions, typically, between the processor and memory 66.

The carton optimization system 95 further includes memory 66, which may comprise non-volatile media (also referred to as non-volatile storage, memory, memory storage, memory circuitry and/or similar terms used herein interchangeably). In one embodiment, the non-volatile storage or memory may include one or more non-volatile storage or memory media as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. In various embodiments, memory 66 includes both read only memory (ROM) 65 and random access memory (RAM) 67. As will be recognized, the non-volatile storage or memory media may store databases, database instances, database management systems, data, applications, programs, program modules, scripts, source code, object code, byte code, compiled code, interpreted code, machine code, executable instructions, and/or the like. Such code may include the historical shipment module 200 and/or the carton optimization module 300. The term database, database instance, database management system, and/or similar terms used herein interchangeably may refer to a structured collection of records or data that is stored in a computer-readable storage medium, such as via a relational database, hierarchical database, and/or network database.

In at least one embodiment, the carton optimization system 95 may further include or be in communication with volatile media (also referred to as volatile storage, memory, memory storage, memory circuitry and/or similar terms used herein interchangeably). In one embodiment, the volatile storage or memory may also include one or more volatile storage or memory media as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processor 60. Thus, the databases, database instances, database management systems, data, applications, programs, program modules, scripts, source code, object code, byte code, compiled code, interpreted code, machine code, executable instructions, and/or the like may be used to control certain aspects of the operation of the carton optimization system 95 with the assistance of the processor and operating system 80, such as the historical shipment module 200 and/or the carton optimization module 300.

In various embodiments, memory 66 can be considered primary memory such as RAM memory or other forms which retain the contents only during operation, or it may be a non-volatile memory, such as ROM, EPROM, EEPROM, FLASH, or other types of memory that retain the memory contents. The memory 66 could also be secondary memory, such as disk storage, that stores a relatively large amount of data. The memory may also comprise any application program interface, system, libraries and any other data by the processor to carry out its functions. ROM 65 is used to store a basic input/output system 26 (BIOS), containing the basic routines that help to transfer information between components of the carton optimization system 95, including the historical module 200, carton optimization module 300, the carton database 400, and/or the operating system 80.

In some embodiments, the disk storage may communicate with the processor 60 using an I/O bus instead of a dedicated bus. The secondary memory may be a floppy disk, hard disk, compact disk, DVD, or any other type of mass storage type known to those skilled in the computer arts. Also included in the carton optimization system 95 is an input/output system 64 for receiving and displaying data. This input/output system 64 may be, for example, a keyboard or pointing device that is used in combination with a monitor.

In addition, the carton optimization system 95 includes at least one storage device 63, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. It is important to note that the computer-readable media described above could be replaced by any other type of computer-readable media known in the art. Such media include, for example, memory sticks (e.g., USB memories), magnetic cassettes, flash memory cards, digital video disks, and Bernoulli cartridges.

A number of program modules may be stored by the various storage devices and within RAM 67. Such program modules include the operating system 80, the historical shipment module 200, and carton optimization module 300. Those skilled in the art will appreciate that other modules may be present in RAM to effectuate the various embodiments of the present invention. Furthermore, rather than program modules, the historical shipment module and carton optimization module may comprise stand-alone computers connectively coupled to the carton optimization system 95.

Also located within the carton optimization system 95 is a network interface 74, for interfacing and communicating with other elements of a computer network, such as by communicating data, content, information, and/or similar terms used herein interchangeably that can be transmitted, received, operated on, processed, displayed, stored, and/or the like. For instance, the carton optimization system 95 may be in communication with consignor computing entities 105. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Various information is input by a user to the carton optimization system 95 via the network interface 74. This input information 86 may include historical shipment details, carton optimization preferences, or other information. This input information may vary, however, depending on the configuration and informational requirements of carton optimization system 95.

The carton optimization system 95 may include or be in communication with one or more input elements, such as a keyboard input, a mouse input, a touch screen/display input, audio input, pointing device input, joystick input, keypad input, and/or the like, as indicated by input/output device 64. The carton optimization system 95 may also include or be in communication with one or more output elements, as indicated by input/output device 64, such as audio output, video output, screen/display output, motion output, movement output, and/or the like.

The carton optimization system 95 outputs the carton optimization results including a list of the different sizes of cartons a consignor should consider keeping in stock. This recommendation may comprise any number of forms, including an electronic signal, a graphic or other indicia presented on an interface, a document, or an audible indication. Those skilled in the art will appreciate that the carton optimization results may take a number of forms within the spirit and scope of embodiments of the present invention.

Those skilled in the art will recognize that many other alternatives and architectures are possible and can be used to practice various embodiments of the invention. The embodiments illustrated in FIG. 2 can be modified in different ways or incorporated within a network and be within the scope of the invention. For example, one or more components of the carton optimization system 95 may be located remotely from other carton optimization system 95 components, such as in a distributed system. Furthermore, one or more of the components may be combined and additional components performing functions described herein may be included in the carton optimization system 95. Thus, the carton optimization system 95 can be adapted to accommodate a variety of needs and circumstances.

### 2. Exemplary Consignor Computing Entity

In one embodiment, each consignor computing entity 105 may include components and functionality that are similar to the carton optimization system 95, such as one or more processors, one or more display device/input devices, volatile and non-volatile storage or memory, and/or one or more communications interfaces (e.g., wired or wireless). These architectures are provided for exemplary purposes only and are not limiting to the various embodiments. The term computing device may refer to one or more computers, computing devices, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions described herein. As will be recognized, although the following describes a carton optimization system 95 executing a historical shipment module 200 and/or a carton optimization module 300, the consignor computing entity 150 can implement/execute such modules as well.

3. Exemplary Carrier System

In one embodiment, a carrier system 110 may include one or more components that are functionally similar to those of the carton optimization system 95. As noted, the terms system, computing entity, entity, device, and/or similar words used herein interchangeably may refer to, for example, one or more computers, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. For example, in one embodiment, the carrier system 110 may include one or more processing elements, one or more display device/input devices, volatile and non-volatile storage or memory, and/or one or more communications interfaces. The carrier system 110 may also comprise various other systems, such as an Address Matching System (AMS), an Internet Membership System (IMS), a Consumer Profile System (CPS), a package level detail (PLD) database, a Package Center Information System (PCIS), a Customized Pickup and Delivery System (CPAD), a Web Content Management System (WCMS), a Notification Email System (NES), a Fraud Prevention System (FPS), and a variety of other systems and their corresponding components. Such carrier systems 110 may be in communication with carton optimization system 95, consignor computing entities 105, and/or other computing devices. In various embodiments, the carrier system 110 may comprise carton database 400.

### III. Exemplary System Operation

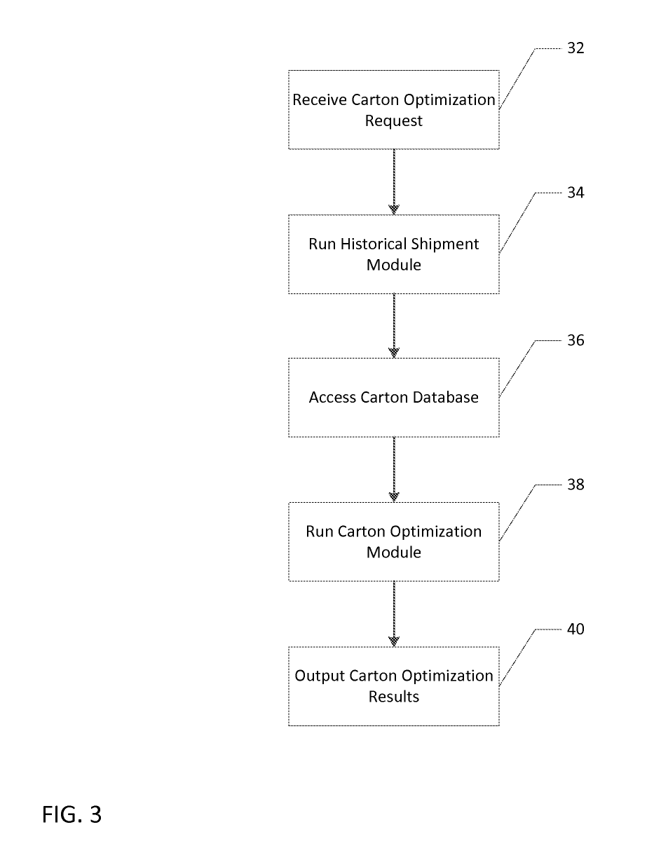

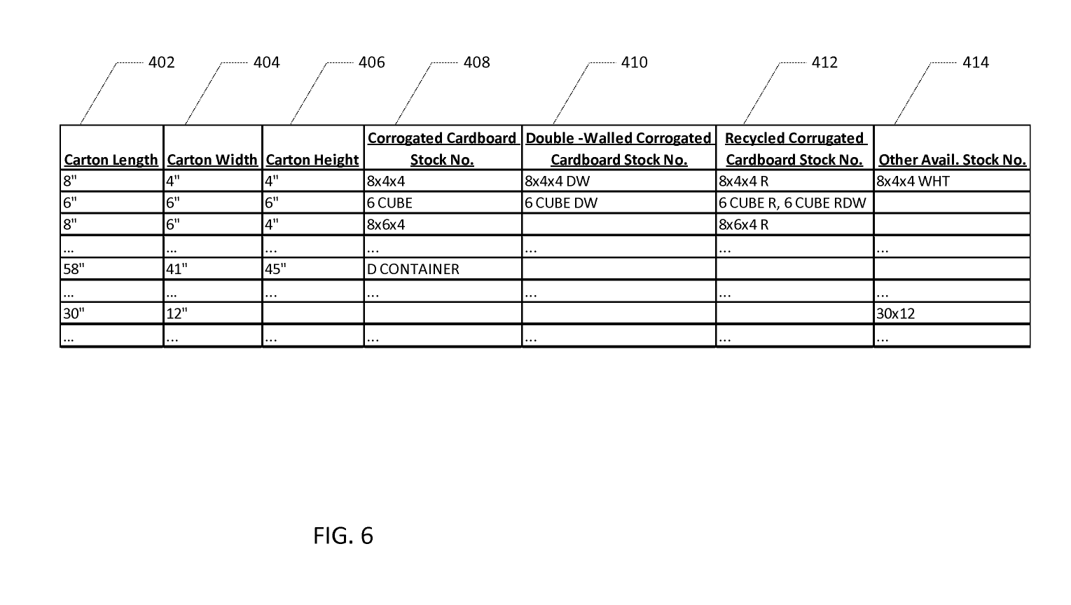

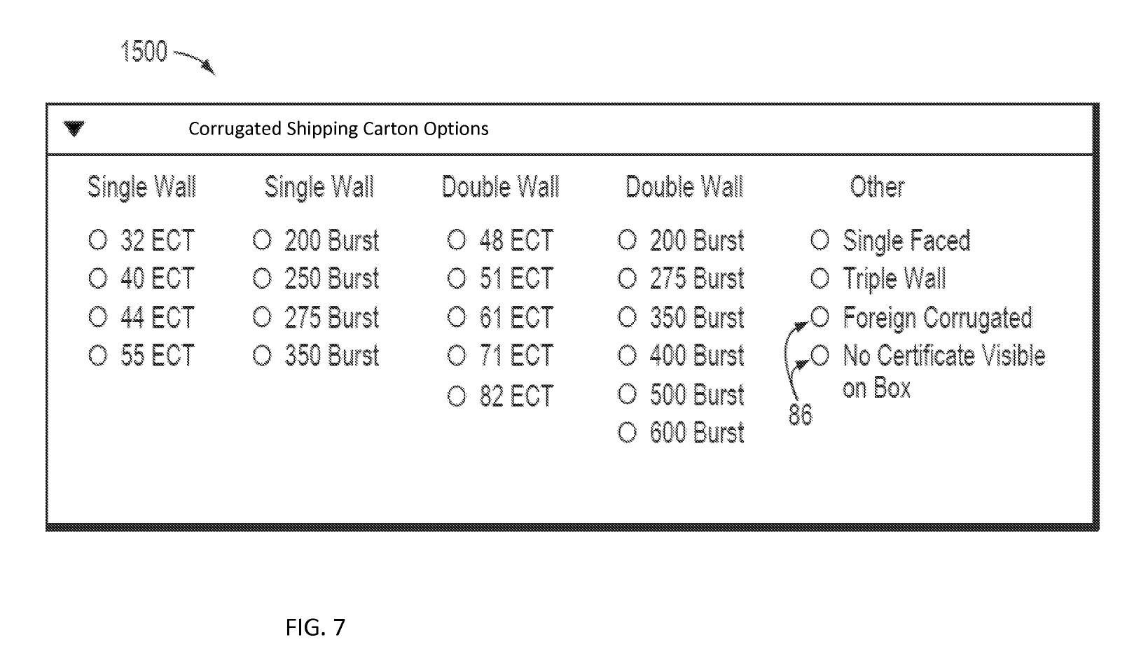

Reference will now be made to FIGS. 3-7. FIGS. 3-5 are flowcharts illustrating operations and processes that may be performed by the carton optimization system 95. FIG. 6 illustrates a portion of a carton database, and FIG. 7 is an example of a screen that may be displayed to a user, such as a consignor.

In one embodiment, the process may begin at step 32 with receiving a carton optimization request. In various embodiments, the carton optimization request may originate from a consignor computing entity 105. In other embodiments, the carton optimization request may originate from a carrier system 110, for example, on behalf of a consignor. In still other embodiments, the carton optimization request may be received by the carton optimization system 95 via input/output system 64 or via some other mechanism. In various embodiments, the carton optimization request may correspond to a specific time period for which historical shipment data should be analyzed to determine a desired optimization level, a desired optimization range, and/or other information.

In response to receipt of the carton optimization request, the carton optimization system 95 may request historical shipping data corresponding to the specific time period for which historical shipment data should be analyzed. In certain embodiments, the historical shipping data may be included as part of the carton optimization request. In other embodiments, the historical shipping data may be provided by the consignor computing entity 105, the carrier system 110, or any other entity that may store or have access to historical shipment data. In various embodiments, the carrier system 95 may receive the historical shipment data from the consignor computing entity 105 or the carrier system 110. For instance, in a particular embodiment, the carton optimization system 95 may be granted permission to access the historical shipment data via a network 120 or other communication network. In yet other embodiments, a user may physically supply the historical shipment data to carton optimization system 95 via a file, attachment, flash drive, CD, or other computer-readable media, as is well known in the art.

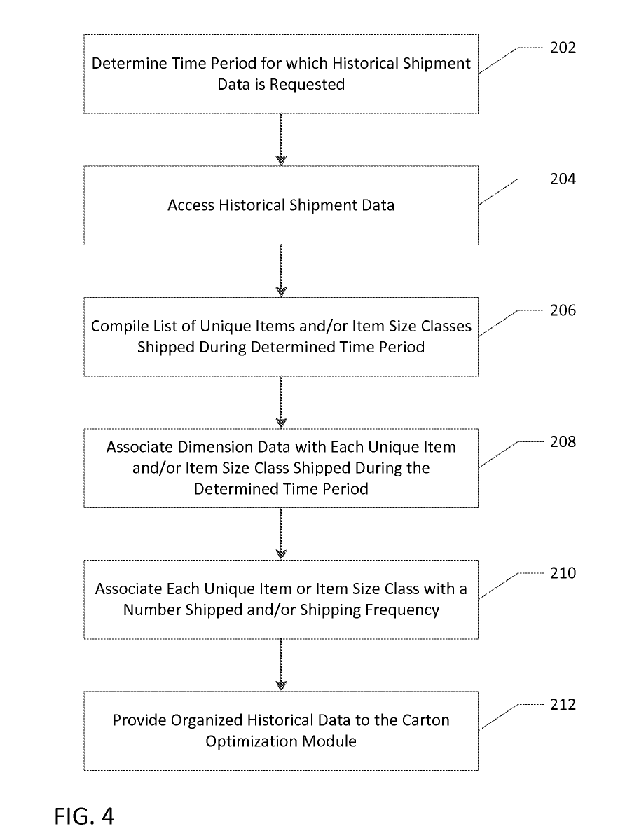

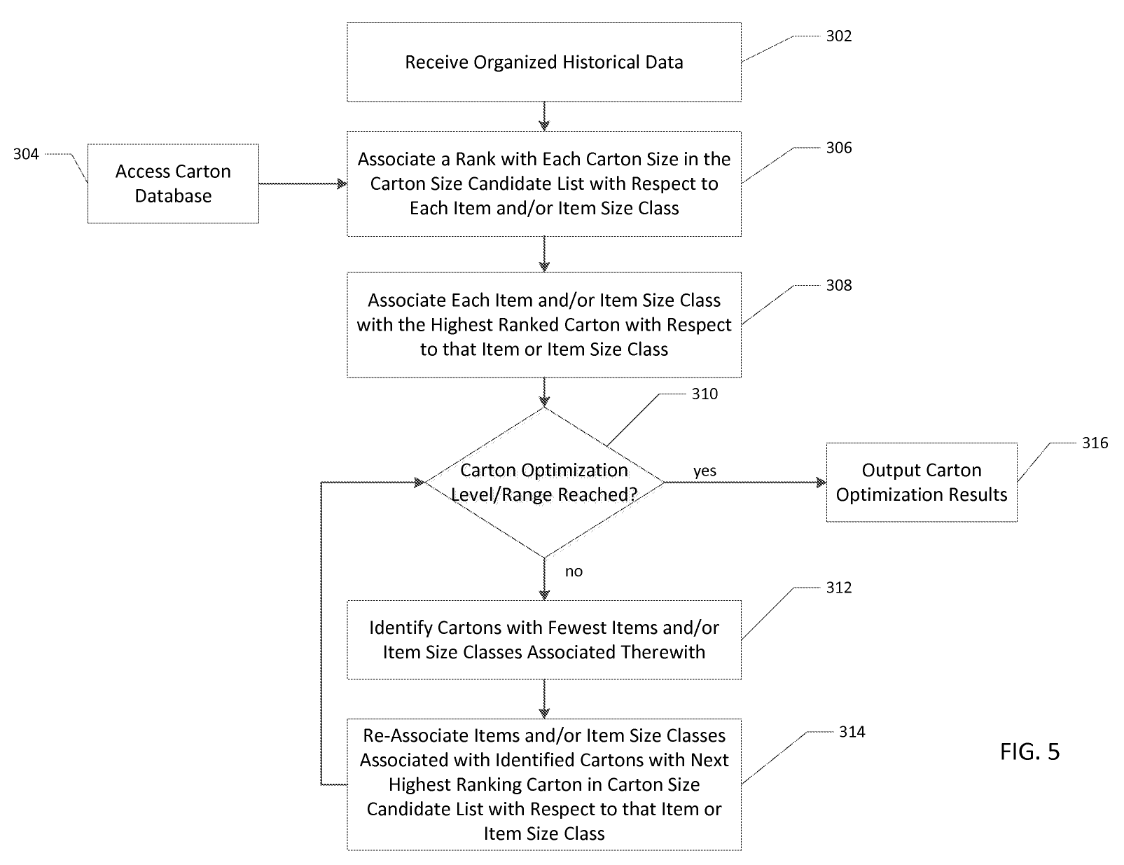

At step 34, the historical shipment module 200 may access the historical shipment data, as will be described in more detail below with reference to FIG. 4. At step 36, the carton optimization system 95 may access the carton database 400, as will be described in more detail below with reference to FIGS. 6 and 7. At step 38, the carton optimization module 300 may complete the carton optimization, as will be described in more detail with reference to FIG. 5 below. At step 40, the carton optimization results may be communicated to the user (e.g., operating a consignor computing entity 105). Various operations and process that may be implemented in various embodiments will now be discussed in detail below.

Historical Shipment Module

FIG. 4 is a flow diagram illustrating the operation of a historical shipment module 200 in accordance with various embodiments of the present invention. The flow diagram shown in FIG. 4 may include processing performed by processor 60 as it executes the historical shipment module 200.

As illustrated in FIG. 4, the historical shipment module 200 starts at step 202 by determining the time period for which the historical shipment data is requested. In various embodiments, the historical shipment data may be requested for a calendar year or fiscal year or longer. In other embodiments, the historical shipment data may be requested for a fiscal year quarter, a season, or a particular month or set of months. For example, a user (e.g., consignor) may be interested in which cartons he or she should keep on hand for fulfilling Christmas orders. In this example, the time period for which historical data is reviewed may be November and December of the previous year. In other embodiments, a portion of the historical shipping data for a year may be reviewed that may be representative of a user's shipping habits at any time during the year. In some embodiments, no time period is determined.

At step 204, the historical shipping data is accessed. As noted above, the historical shipping data may be transmitted to the carton optimization system 95 and accessed therefrom. In other embodiments, the historical shipping data may be assessed from a consignor's computing entity 105 or other computing entity over a network 120 or the like. In still other embodiments, the historical shipping data may be provided to the carton optimization system 95 via computer-readable media, such as a floppy disk, flash disk, CD, or other computer-readable media, and accessed therefrom. In yet other embodiments, the historical shipping data may be input directly into the carton optimization system 95 via the input/output system 64. In various embodiments, the historical shipping data is accessed only for the determined time period. In other embodiments, all accessible historical shipping data is accessed.

In various embodiments, the accessed historical shipping data may comprise identifying information about which products were shipped during the identified time period, the dimensions of the shipped products, the dimensions of the packaging (e.g., cartons) of the shipped products, locations to which products were shipped, the fragility class of the shipped products, customer complaints about products damaged during shipping, and/or other information relevant to shipments completed during the determined historical time period. In various embodiments, the dimensions of the shipped products and/or the dimensions of the packaging of the shipped products may comprise height, length, and width measurements, volume measurements, diameter measurements, diagonal height, length, and width measurements, and/or various other measurements.

Various embodiments continue at step 206 by identifying the unique items that may comprise the accessed historical shipping data. In various embodiments, the identified unique items comprise the organized historical data. In various embodiments, unique items may be identified by stock-keeping unit (SKU) number, international standard book number (ISBN), product name, product description, or any other identifiers or information associated with the items comprising the accessed historical shipping data. In some embodiments, the list may not be of unique items, but of item size classes. Thus, in some embodiments, the organized historical data comprises classes of items which are approximately the same size. For example, the organized historical data may include one entry for all music CDs, even if the accessed historical shipping data comprises a Madonna CD, a Rush CD, a Moody Blues CD, and/or a Taylor Swift CD. In various embodiments, the organized historical data may comprise only unique items, only item size classes, and/or a combination thereof.

At step 208, in various embodiments, each item comprising the organized historical data may be associated with dimensional data. In various embodiments, the accessed historical shipping data comprises product dimensional data. In other embodiments, the product dimensional data may be accessed via a product catalog or other source. In various embodiments, the dimensional data comprises the product height, length, and width when the product is within the product packaging. In other embodiments, other dimensional data may be included, such as the various dimensional data types noted above or other dimensional data types.

According to various embodiments, at step 210, each unique item or item size class may be associated with a number shipped corresponding to the number of that item that were shipped according to the historical shipping data during the determined time period. For example, during the determined time period, 10 baseballs may have been shipped. Thus, in this example, the number shipped associated with the baseball is 10. In various embodiments, a shipping frequency may be associated with each entry on the list of unique items. For example, when averaged over the determined time period, 1 baseball may have been shipped per week, or 1.5 baseballs may have been shipped per day, or 6.2 baseballs may have been shipped per month. It will be appreciated that a variety of alternatives to the shipping frequency or number shipped indicators may be used without departing from the scope of the present invention.

In various embodiments, the historical shipping module 200 may provide the carton optimization module 300 with the organized historical shipping data at step 212. In various embodiments, the historical shipping module 200 may provide the carton optimization module 300 with the organized historical data. In some embodiments, the historical shipping module 200 may also provide the carton optimization module 300 with the dimensional data associated with each of the unique items, the number of times each unique item was shipped during the determined time period, the shipping frequency of each unique item, the fragility class associated with each unique item, delivery location information associated with at least one item and/or other data associated with at least one item or item size class comprising the organized historical data.

As will be recognized, many other alternatives to the historical shipping module 200 and its operations are possible and can be used to practice various embodiments of the invention. The embodiments illustrated in FIG. 4 can be modified in different ways or incorporated within other processes, for instance.

Carton Optimization Module

FIG. 5 is a flow diagram illustrating the operation of the carton optimization module 300 in accordance with various embodiments of the present invention. The flow diagram shown in FIG. 5 may include processing performed by processor 60 as it executes the carton optimization module 300.

In embodiment illustrated in FIG. 5, the carton optimization module 300 starts at step 302 by receiving the organized historical data from the historical shipping module 200. In other embodiments, the carton optimization module 300 may access the organized historical data from a location where it was stored by the historical shipping module 200. In other embodiments, some or all of the functions of the historical shipping module 200 may be completed by the carton optimization module 300.

At step 304, in various embodiments, the carton optimization module 300 may access the carton database 400. FIG. 6 illustrates some of the information which may be stored in the carton database 400, in various embodiments. For example, in various embodiments, the carton database 400 may comprise the carton length 402, carton width 404, and carton height 406 of various cartons. In various embodiments, the carton database 400 may also comprise stock numbers of the cartons, such as corrugated cardboard containers 408, stock numbers of double-walled corrugated cardboard containers 410, stock numbers of cardboard containers that are at least in part made of recycled cardboard 412, and/or other numbers of available containers 414. In various embodiments, the carton database 400 may store other information corresponding to various carton sizes or carton stock numbers to which a consignor has access (e.g., the ability to stock). For example, one or more carton stock numbers listed in the carton database 400 may be associated with an edge crush test (ECT) rating or a burst test (Mullen test) rating.

In various embodiments, a user may be presented with a user interface screen 1500, such as that displayed in FIG. 7, wherein the user (e.g., consignor) may select certain kinds of cartons he or she would like to stock. In the embodiment illustrated in FIG. 7, a user may select certain kinds of cartons via radio buttons 86. In other embodiments, a user may use a different method to indicate certain kinds of cartons he or she would like to stock or have the ability to stock. For example, a certain user may only wish to ship items using double-walled corrugated cardboard containers or containers that score at or above a certain level in an ECT and/or burst test (i.e., Mullen test), or cartons that score within a certain range in an ECT and/or burst test. In one embodiment, the user (e.g., consignor) may therefore indicate this preference via a user interface screen 1500, in the carton optimization request, or via some other mechanism. As a result of the user's carton preferences, the carton size candidate list considered by the carton optimization module 300 may comprise carton sizes that are available or accessible to the consignor. In other embodiments, the carton size candidate list may be determined automatically based on information associated with at least one of the items comprising the organized historical data. In this example, if at least some fraction of items in the organized historical data are indicated as being very fragile, or are associated with a fragility class indicating they are very fragile, the carton size candidate list may comprise carton sizes for which cartons are available that are appropriate for fragile items. In another example, if the delivery information associated with at least some fraction of items comprising the organized historical shipping data indicates that the items are being delivered outside of the country where the shipment originated, the carton size candidate list may comprise carton sizes for which cartons are available that are appropriate for cross-border shipments. In certain embodiments, at least some fraction of items may relate to greater than 10% of all items, greater than 25% of all items, greater than 50% of all items, greater than 75% of all items, or greater than 90% of all items. In various embodiments, the carton size candidate list may comprise cartons of various sizes.

In various embodiments, a user (e.g., consignor) may request custom cartons. In such embodiments, a custom carton size candidate list may be accessed or received specific to that user (and included as part of the candidate list). In other such embodiments, the carton optimization module 300 may determine what size custom cartons would be most beneficial for the user. It should be appreciated that a variety of alternatives to a carton size candidate list may be used in various embodiments of the present invention.

Returning to FIG. 5, in various embodiments, the carton optimization module 300 may associate a rank with each carton size comprising the carton size candidate list with respect to each item or item size class comprising the organized historical data at step 306. In various embodiments, the rank associated with a carton size with respect to an item may be based at least in part on the height, length, and width of the carton and the height, length and width of the product and/or product packaging. Returning to the baseball example above, the baseball and its packaging may have height, length, and width dimensions of 3.25 inches by 3.25 inches by 3.25 inches. In this non-limiting example, carton A has dimensions 4 inches by 3.5 inches by 3.5 inches and carton B has dimensions 5 inches by 3.5 inches by 3.5 inches. With respect to the baseball, carton A would be ranked higher than Carton B. Additionally, in this example, if carton C had dimensions 2 inches by 3.5 inches by 3.5 inches, carton C may be associated with a rank indicating carton C is unacceptable for shipping the baseball because carton C is too small in at least one dimension for the baseball to fit in carton C. In other embodiments, the rank associated with a carton with respect to an item or item size class may be based at least in part on the volume of the carton and the volume of the product and/or packaging. Staying with the baseball example, the baseball and packaging has a volume of about 34.3 cubic inches, carton A has a volume of 49.0 cubic inches, carton B has a volume of 61.3 cubic inches, and carton C has a volume of 24.5 cubic inches. Thus, in this example, carton A would be ranked higher than carton B with respect to the baseball because the volume of carton A is closer to the volume of the baseball and its packaging than carton B. Similarly, carton C may be associated with a rank indicating that carton C may be unacceptable for shipping the baseball since the volume of carton C is less than the volume of the baseball and its packaging. In other embodiments, the rank associated with a carton size with respect to an item may be based on the percentage or fraction of the volume of the carton for which the product and its packaging account. Remaining with the baseball example, the baseball and its packaging account for 70% of the volume of carton A, 56% of the volume of carton B, and 140% of the volume of carton C. Thus, in this example, carton A may be associated with a higher rank than carton B with respect to the baseball. Carton C may be associated with a rank indicating that carton C may be unacceptable for shipping the baseball since the baseball and its packing account for more than 100% of the volume of carton C. In yet other embodiments, other various ranking systems may be used and/or combinations of the ranking systems described herein.

In various embodiments, the carton optimization module, at step 308, may associate each item or item size class comprising the organized historical data with at least one of the carton sizes comprising the carton size candidate list. In some such embodiments, each item or item size class will be associated with the at least one carton size associated with the highest rank with respect to that item or item size class. In some embodiments, each item or item size class will be associated with only one carton size. In some embodiments, the each item or item size class comprising the organized historical data will be associated with a carton size once. In still other embodiments, each unique item or item size class may be associated with a carton size one or more times. For example, an item may be associated with a carton size the same number of times as the number shipped associated with the item, the shipping frequency associated with the item, an expected number shipped or shipping due to future sales, or some other number of times. In various embodiments, each item size class may be associated with a carton size as many times as there are unique items in that size class. For example, returning to the CD example above, 4 different CDs were shipped according to the historical shipping data. Therefore, in this example, the item size class “CD” may be associated with a specific carton size 4 times.

As noted above, in various embodiments, a carton optimization request may comprise a carton optimization level or range. Thus, in various embodiments, the carton optimization request may indicate the number of carton sizes or a range of number of carton sizes a user (e.g., consignor) would like to keep in stock. For example, a user (e.g., consignor) may wish to stock 10 different carton sizes or 9-12 different carton sizes. Thus, in this non-limiting example, the carton optimization module may determine the 10 different cartons sizes or 9-12 different carton sizes the user should keep in stock in order to optimize the user's in stock carton sizes. In other embodiments, the carton optimization request may not comprise a carton optimization level or range. In various such embodiments, a carton optimization level or range request may be presented to the user (e.g., consignor) via the consignor computing entity 105, for example. In other embodiments, the carton optimization module 300, historical shipping module 200, or some other module or computing entity in communication with the carton optimization system 95 may determine a carton optimization level or range. In various embodiments, the carton optimization level or range may be determined at least in part based on the historical shipping data, the organized historical data, information that may be present in a user's profile (in embodiments that include a user profile), or other available information. In some embodiments, the carton optimization level or range may be determined at least in part based on the number of items and/or item size classes comprising the organized historical data. In some embodiments, the carton optimization level may be chosen from a group of possible carton optimization levels that may comprise 5, 10, 15, 20, 25, and/or other numbers of carton sizes. In some embodiments, the carton optimization range may be chosen from a group of possible carton optimization ranges that may comprise 4-8, 8-12, 12-18, 18-22, 22-27, and/or other ranges of numbers of carton sizes. It will be appreciated that a variety of alternatives to the carton optimization level and/or carton optimization range may be used without departing from the scope of the present invention.

At step 310, in various embodiments, the carton optimization may compare the number of carton sizes comprising the carton size candidate list to the received or determined carton optimization level or range. If the number of carton sizes comprising the carton size candidate list is greater than the carton optimization level or range, the carton optimization module continues to step 312. If the number of carton sizes comprising the carton size candidate list is equal to or less than the carton optimization level or within or below the carton optimization range, the carton optimization module continues to step 316.

At step 312, in various embodiments, the carton sizes having the fewest number of items associated therewith are identified. In various embodiments, the identified carton sizes may be removed from the carton size candidate list. In various embodiments, the carton size with the fewest number of items associated therewith, or the carton size having the smallest percentage of items associated therewith may be removed from the carton size candidate list. In other embodiments, the two or more carton sizes having the fewest number of items or the smallest percentage of items associated therewith may be removed from the carton size candidate list. In other embodiments, carton sizes may not be removed from the carton size candidate list, instead, the rank associated with the carton size or sizes having the least number of items or smallest percentage of items associated therewith may be updated to indicate the carton size or sizes may be unacceptable with respect to all items and/or item size classes. In other embodiments, the one or more carton sizes having the least number of items or smallest percentage of items associated therewith may be identified and removed from the consideration of the carton optimization module 300 in some other manner. In yet other embodiments, the one or more carton sizes having the least number of items or the smallest percentage of items associated therewith may be identified, but not removed from consideration of the carton optimization module 300.

In various embodiments, the number of carton sizes identified may be pre-determined. For example, in at least one embodiment, the carton optimization module 300 may always identify two carton sizes at step 312. In other embodiments, the carton optimization module 300 may always identify one carton at step 312. In other embodiments, the number of carton sizes identified may depend on the difference between the number of carton sizes comprising the carton size candidate list and the carton optimization level or range. In still other embodiments, the number of carton sizes identified at step 312 may depend on the ratio of the number of carton sizes comprising the carton size candidate list and the carton optimization level or range. In yet other embodiments, a different method may be used to determine how many carton sizes the carton optimization module 300 may identify at step 312. In various embodiments, the number of cartons identified at step 312 may or may not correspond to the number of carton sizes identified when the carton optimization module 300 completed step 312 on a previous iteration.

At step 314, in various embodiments, the items and/or item size classes associated with the one or more carton sizes identified in step 312 are re-associated with other carton sizes. In various embodiments, an item that had been associated with a carton size identified in step 312 may be associated with the next highest ranking carton size on the carton size candidate list. As noted above, each unique item or item size class may be associated with a carton size once, a number of times corresponding to the number shipped or shipping frequency associated with the item or item size class, or some other number of times.

In various embodiments, the carton optimization module 300 returns to step 310 to determine if the number of carton sizes comprising the carton size candidate list is equal to or less than the carton optimization level or within or below the carton optimization range. If the carton optimization module 300 determines the carton optimization level or range has been reached, the carton optimization module continues to step 316. If the carton optimization module 300 determines the carton optimization level or range has not been reached, the carton optimization module returns to step 312. Steps 312, 314, and 310 may be repeated as many times as necessary to reach the carton optimization level or range or as many times as desired. For example, in some embodiments, steps 312, 314, and 310 may be repeated until the carton optimization level or range is reached, or, in other embodiments, steps 312, 314, and 310 may only be repeated 10 times or 50 times or some other number of times. In other embodiments, steps 312, 314, and 310 may be iterated until carton size candidate level reaches a steady state solution.

In various embodiments, once the carton optimization level or range is reached or steps 312, 314, and 310 have been repeated a pre-determined number of times, the carton optimization module 300 continues to step 316. In various embodiments, step 316 may be completed in each iteration of steps 312, 314, and/or step 310. In various embodiments, the carton optimization module 300 may not complete step 310 and may complete step 316 in place of step 310 on each iteration.

In various embodiments, at step 316, the carton optimization module 300 outputs the results of the carton optimization module. In various embodiments, the carton optimization module 300 may output the carton size candidate list. In some such embodiments, the carton optimization module 300 may output the carton size candidate list, the items and/or item size classes associated with each carton size, and/or the information associated with at least one item and/or item size class. In other embodiments, the carton optimization results may take other forms.

In various embodiments, the results of the carton optimization module 300 may be output in a variety of ways. In some embodiments, the output may be displayed via input/out system. In other embodiments, the output may be transmitted via network interface 74 to the consignor computer entity 105, the carrier system 110, or some other computing entity. In some embodiments, the output may be in the form of a print out, fax, email, text message, voice mail message, or other human or computer-readable format. In some embodiments, the output of the carton optimization module 300 is saved to the memory, a memory device, a memory component of the carrier system 110, a memory component of the consignor computer entity 105, or some other computer-readable media. In some such embodiments, a notification that the carton optimization module output has been stored and/or the location to which the output has been stored may be transmitted in any of a variety of human or machine-readable forms well known or commonly used in the art. It should be appreciated that any of a variety of methods for outputting, storing, and/or notifying, or any combination thereof, commonly known and used in the art may be used to complete step 316 in part or in whole.

Those with ordinary skill will recognize that many other alternatives to carton optimization module 300 and its operations are possible and can be used to practice various embodiments of the invention. The embodiments illustrated in the figures can be modified in different ways or incorporated within other processes and be within the scope of the invention.

### IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for carton inventory optimization comprising the steps of:
(a) receiving historical shipping data corresponding to a time period, the historical shipping data comprising items that have been shipped during the time period and their respective dimensions;
(b) associating a rank to each of a plurality of carton sizes for each item;
(c) associating a highest ranked carton size for each item based at least in part on step (b); and
(d) determining whether a desired level of optimization has been reached.

2. The method of claim 1 further comprising the steps:
(e) after determining that the desired level of optimization has not been reached, identifying at least one carton size; and
(f) re-associating items that were associated with the at least one identified carton size to the next highest ranked carton size for each item.

3. The method of claim 2 wherein the steps (d), (e), and (f) are repeated until the desired level of optimization is reached.

4. The method of claim 1 wherein the dimensions of the items include height, length, and width of a product including the product packing.

5. The method of claim 1 wherein the rank associated to each of the plurality of carton sizes for each item is based at least in part on a comparison of the dimensions of the historical shipment items and the dimensions of the carton.

6. The method of claim 1 wherein the rank associated to each of the plurality of carton sizes for each item is based at least in part on a comparison of the volume of the item and the volume of the carton.

7. The method of claim 1 wherein the at least one identified carton is the carton with which the least number of items are associated.

8. The method of claim 1 wherein the at least one identified carton is the carton with which the smallest percentage of items are associated.

9. The method of claim 1 wherein step (c) comprises associating each unique item with the highest ranked carton once.

10. The method of claim 1 wherein step (c) comprises associating each shipped item with the highest ranked carton once.

11. The method of claim 1 wherein step (c) comprises associating each unique item with the highest ranked carton one or more times based at least in part on expected sales of the unique item.

12. The method of claim 1 wherein the desired level of optimization is a number of different sizes of cartons a shipper would like to keep in stock.

13. The method of claim 1 wherein the desired level of optimization is a range of numbers of different sizes of cartons a shipper would like to keep in stock.

14. The method of claim 1 wherein one or more unique items are combined into an item size class.

15. A system comprising one or more memory storage areas and one or more processors, the one or more processors configured to:
(a) receive historical shipping data corresponding to a time period, the historical shipping data comprising items that have been shipped during the time period and their respective dimensions;
(b) associate a rank to each of a plurality of carton sizes for each item;
(c) associate a highest ranked carton size for each item at least in part on (b); and
(d) determine whether a desired level of optimization has been reached.

16. The system of claim 15 further configured to:
(e) after it is determined that the desired level of optimization has not been reached, identify at least one carton size; and
(f) re-associate items that were associated with the at least one identified carton size to the next highest ranked carton size for each item.

17. The system of claim 16 further configured to repeat (d), (e), and (f) until the desired level of optimization is reached.

18. The system of claim 15 wherein the dimensions of the items include height, length, and width of a product including the product packing.

19. The system of claim 15 wherein the rank associated to each of the plurality of carton sizes for each item is based at least in part on a comparison of the dimensions of the items and the dimensions of the carton.

20. The system of claim 15 wherein the rank associated to each of the plurality of carton sizes for each item is based at least in part on a comparison of the volume of the item and the volume of the carton.

21. The system of claim 15 wherein the at least one identified carton is the carton with which the least number of items are associated.

22. The system of claim 15 wherein the at least one identified carton is the carton with which the smallest percentage of items are associated.

23. The system of claim 15 wherein (c) comprises associating each unique item with the highest ranked carton once.

24. The system of claim 15 wherein (c) comprises associating each shipped item with the highest ranked carton once.

25. The system of claim 15 wherein (c) comprises associating each unique item with the highest ranked carton one or more times based at least in part on expected sales of the unique item.

26. The system of claim 15 wherein the desired level of optimization is a number of different sizes of cartons a shipper would like to keep in stock.

27. The system of claim 15 wherein the desired level of optimization is a range of numbers of different sizes of cartons a shipper would like to keep in stock.

28. The system of claim 15 wherein one or more unique items are combined into an item size class.

29. A computer program product comprising at least one computer-readable storage medium having computer-readable program code portions stored therein, the computer-readable program code portions comprising:
(a) an executable portion configured to receive historical shipping data corresponding to a time period, the historical shipping data comprising items that have been shipped during the time period and their respective dimensions;
(b) an executable portion configured to associate a rank to each of a plurality of carton sizes for each item;
(c) an executable portion configured to associate a highest ranked carton size for each item at least in part on (b); and
(d) an executable portion configured to determine whether a desired level of optimization has been reached.

30. The computer program product of claim 29, the computer-readable program code portions further comprising:
(e) an executable portion configured to, after it is determined that the desired level of optimization has not been reached, identify at least one carton size; and
(f) an executable portion configured to re-associate items that were associated with the at least one identified carton size to the next highest ranked carton size for each item.

31. The computer program product of claim 30 further configured to repeat (d), (e), and (f) until the desired level of optimization is reached.

32. The computer program product of claim 29 wherein the dimensions of the items include height, length, and width of a product including the product packing.

33. The computer program product of claim 29 wherein the rank associated to each of the plurality of carton sizes for each item is based at least in part on a comparison of the dimensions of the items and the dimensions of the carton.

34. The computer program product of claim 29 wherein the rank associated to each of the plurality of carton sizes for each item is based at least in part on a comparison of the volume of the item and the volume of the carton.

35. The computer program product of claim 29 wherein the at least one identified carton is the carton with which the least number of items are associated.

36. The computer program product of claim 29 wherein the at least one identified carton is the carton with which the smallest percentage of items are associated.

37. The computer program product of claim 29 wherein (c) comprises associating each unique item with the highest ranked carton once.

38. The computer program product of claim 29 wherein (c) comprises associating each shipped item with the highest ranked carton once.

39. The computer program product of claim 29 wherein (c) comprises associating each unique item with the highest ranked carton one or more times based at least in part on expected sales of the unique item.

40. The computer program product of claim 29 wherein the desired level of optimization is a number of different sizes of cartons a shipper would like to keep in stock.

41. The computer program product of claim 29 wherein the desired level of optimization is a range of numbers of different sizes of cartons a shipper would like to keep in stock.

42. The computer program product of claim 29 wherein one or more unique items are combined into an item size class.
